(19) United States
(12) Patent Application Publication
(10) Pub. No.: US 2024/0283689 A1
(43) Pub. Date: Aug. 22, 2024

(54) Method And Apparatus Of Point To Multi-Point Transmission In An OFDM Network

(71) Applicant: Nokia Solutions and Networks Oy, Espoo (FI)

(72) Inventor: Di Che, Union, NJ (US)

(73) Assignee: Nokia Solutions and Networks Oy, Espoo (FI)

(21) Appl. No.: 18/133,081

(22) Filed: Apr. 11, 2023

Related U.S. Application Data
(60) Provisional application No. 63/446,954, filed on Feb. 20, 2023.

(51) Int. Cl. H04L 27/26; H04L 5/00

(52) U.S. Cl. CPC H04L 27/2627; H04L 5/006

(57) ABSTRACT

A method and apparatus for processing of signals in a point-to-multipoint (P2MP) network are provided. The processing includes obtaining link conditions, in a spectrum comprising multiple OFDM subcarriers, of a plurality of users at respective user nodes that are in communication with a central node of the network. The processing further includes inputting the link conditions to an entropy loading (EL) algorithm, thereby to determine a modulation format for each of the OFDM subcarriers; optimizing an allocation of OFDM subcarriers to users according to an OFDMA scheme; and for each user, loading data from a bitstream onto the allocated OFDM subcarriers in the respective determined modulation formats.

### CROSS-REFERENCE TO RELATED APPLICATION

This application claims priority to U.S. Provisional Patent Application Ser. No. 63/446,954 filed Feb. 20, 2023 under the title, “Method and Apparatus of Point-To-Multipoint Transmission in an OFDM Network.”

### TECHNICAL FIELD

The present disclosure relates to data communication in point-to-multipoint networks.

### BACKGROUND

A passive optical network (PON) is a variety of fiber optic access network that uses a point-to-multipoint (P2MP) topology to deliver network access to end users. Typically, downstream transmissions are broadcast from an optical line terminal (OLT) at a central hub to plural optical network units (ONUs) or optical network terminals (ONTs) situated near the end users. Passive components such as fiber optic splitters distribute the downstream transmissions among the ONUs or ONTs. Upstream signals are typically combined using time-division multiple access (TDMA) or another suitable multiple access protocol.

One modulation scheme that has been favored for PON is intensity-modulation direct-detection (IM-DD). In IM-DD, the radio-frequency data signal modulates the intensity of an optical carrier. For demodulation, the optical carrier is directly detected and converted to the electrical domain by a photodetector.

Network planners have predicted a growing diversity in the types of users that a future P2MP will need to support, including diversity in rate demand and diversity in link quality. Such predictions militate for P2MP networks, including P2MP IM-DD networks, with enhanced flexibility.

Aside from optical fiber networks, DOCSIS (cable access) and wireless networks may also have P2MP topologies, and similar challenges may apply to them as well.

### SUMMARY

Current PON networks generally provide fixed aggregated bitrates imposed by the worst-case user in the network, irrespective of user diversity. As a consequence, network capacity may be underutilized, particularly when there is great diversity among the users. To address this problem, designers have proposed adding rate adaptation to existing PON designs based on TDM. For example, R. van der Linden et al., “Increasing flexibility and capacity in real PON deployments by using 2/4/8-PAM formats,” Journal of Optical Communications and Networking, vol. 9, no. 1, pp. A1-A8, (2017), have proposed to support multiple formats like PAM-2/4/8 with a coarse rate granularity. The abrupt rate cliff between two different formats can be shrunk by flexible rate forward error correction (FEC) codes and probabilistic shaping (PS). See, for example, R. Borkowski et al., “FLCS-PON—an opportunistic 100 Gbit/s flexible PON prototype with probabilistic shaping and soft-input FEC: operator trial and ODN case studies,” Journal of Optical Communications and Networking, vol. 14, no. 6, pp. C82-C91, (2022).

Orthogonal Frequency Division Multiplexing (OFDM) is a type of digital transmission in which an incoming bitstream is divided among a multiplicity of closely spaced orthogonal subcarriers. Each subcarrier is modulated with selected bits from the incoming bitstream. The subcarrier signals, which typically have overlapping spectra, are transmitted in parallel. Cyclic prefixes can be added to transmitted symbols, to suppress intersymbol interference and to facilitate frequency-domain processing.

OFDM offers the potential for relatively high flexibility. It also offers the opportunity for adaptive bit loading (BL), which is a known technique for increasing the achievable data rate toward the bandwidth-limited channel capacity. In BL, the signal-to-noise ratio (SNR) of a given subcarrier determines how many bits are assigned to it.

In a P2MP network, OFDM can serve multiple users by time division multiplexing (TDM) among users, with each user fully occupying the available spectrum, i.e., the full range of available subcarriers. In other approaches, flexibility can be enhanced by dividing the spectrum among users according to a scheme of orthogonal frequency division multiple access (OFDMA).

Information theory predicts that a favorable capacity-approaching strategy for bandwidth-limited channels is the well-known water-filling strategy, supported by multicarrier (MC) modulation to decompose high-speed signals to series of low-symbol-rate subcarriers (as in OFDM), and to adapt their modulations based on the SNR response. BL is one example of an algorithm that approximates water filling. BL assigns various discrete bit levels to subcarriers.

EL is another example of an algorithm that approximates water filling. EL is discussed, for example, in D. Che et al, “Approaching the capacity of colored-SNR optical channels by multicarrier entropy loading.” J. Lightwave Technol. 36(1), 68-78 (2018), the entirety of which is hereby incorporated herein by reference.

In BL, rate adaptation can be applied only in whole increments of the entropy, as, for example, in the series of modulation formats QAM-4, QAM-8, QAM-16, etc. By contrast, EL loads continuous entropies, rather than discrete bit levels, to the subcarriers. As a practical matter, this means that entropy can be loaded with relatively high resolution, or in other words, with small granularity. EL also benefits from shaping gain, due to the use of probabilistic shaping (PS).

Disclosed herein is a new, OFDMA-based technique of downstream P2MP transmission that uses entropy loading (EL) for enhanced flexibility among diverse users.

In embodiments, our new technique also employs subcarrier grouping (SCG). Under SCG, respective groups of subcarriers are assigned to individual users, and each subcarrier group is modulated with a single modulation format.

As mentioned above, EL offers a fine granularity for entropy. This may make it advantageous to combine EL with SCG for the following reason: Total data rate is the product of entropy times bandwidth. Hence, for a given degree of rate adaptation, reducing the granularity for entropy permits the frequency resolution, which in OFDMA is the bandwidth per subcarrier, to broaden. Because the continuous adjustment of entropy relaxes the frequency granularity. EL can theoretically perform well in a network with relatively few subcarriers (or in a SCG system with larger number of subcarriers per group), and, potentially, could even outperform BL in such a network.

A discussion of SCG appears in Z. Liu et al., “Linear constellation precoding for OFDM with maximum multipath diversity and coding gains,” IEEE Transactions on Communications, vol. 51, no. 3, pp. 416-427. (2003), where it was proposed to simplify OFDMA-BL as specified, for example, in the DOCSIS 3.1 and Wi-Fi 6 standards.

However, our new approach offers certain distinct advantages. One advantage is that our SCG algorithm can assign a group of subcarriers to each user, under a rule that gives higher priority for assignment of better subcarriers to poorer users. With OFDMA, this approach can achieve multiuser diversity gain that can, for example, extend network coverage to outlying users with extremely bad link quality.

A second advantage is that EL offers PS gain to an OFDMA system, which can lead to relatively higher data rates than the traditional BL-OFDMA. Moreover, owing to the fine rate granularity of a PS format, relatively many SCs can be grouped together without suffering a substantial rate penalty. This, in turn, can greatly simplify the per-SC based OFDM-EL. In particular, it can make it practical to assign only a single format per group for an OFDMA user, which would make OFDMA more attractive than OFDM-TDM because it can greatly simplify the signal processing for end users.

It should be understood that the principles described here are applicable not only to PON, but to other network architectures as well. In particular, they have broad application to P2MP networks of all kinds, including DOCSIS, Wi-Fi, and 5G/6G cellular networks. It should also be understood that although the exemplary embodiment described below is designed for downstream transmission, these principles have application for upstream transmission as well. In particular, there are applications for wireless networks, which are free of the difficulties with optical beat interference that are encountered with upstream transmission in optical P2MP networks. Accordingly, both upstream and downstream transmission in a broad variety of P2MP networks should be understood as falling within the scope of the present disclosure.

Accordingly, the disclosure relates in a first aspect to a method in which are obtained the link conditions of a plurality of users at respective user nodes of a point-to-multipoint (P2MP) network that are in communication with a central node of the P2MP network. For each user, the link condition is determined for each subcarrier in a spectrum comprising multiple OFDM subcarriers. Further according to the method, the link conditions are input to an entropy loading (EL) algorithm, thereby to determine a modulation format for each of the OFDM subcarriers. The method optimizes an allocation of OFDM subcarriers to users according to an OFDMA scheme and, for each user, loads data from a bitstream onto the allocated OFDM subcarriers in the respective determined modulation formats.

The P2MP network may, e.g., be a PON, and the loading of the data for each user may, e.g., comprise optical OFDM modulation.

In embodiments, the method further comprises transmitting the loaded data in parallel, between the user nodes and the central node, on the OFDM subcarriers. The loaded data may, for example, be transmitted in parallel from the central node to the user nodes.

In some embodiments, the optimizing an allocation of OFDM subcarriers may comprise maximizing a data rate. In other embodiments, the optimizing may comprise minimizing a bit error rate.

In some embodiments, the optimizing an allocation of OFDM subchannels to users comprises grouping at least some of the subcarriers into one or more SC groups and allocating each SC group to a respective user. In some such embodiments, the EL algorithm provides, as output, a signal entropy and a net bit rate for each subcarrier under the link condition of each user, and the grouping of subcarriers comprises:

Selecting a user m; from a set of available subcarriers, sorting the subcarriers in descending order of their net bit rates based on the link condition of user m; taking subcarriers in the sorted order from highest to lowest rate and binning them until their collective net bit rate reaches or exceeds a bit-rate target for user m; designating the binned subcarriers as subcarrier group m; removing the subcarriers of subcarrier group m from the set of available subcarriers; and repeating the selecting, sorting, taking, designating, and removing steps for respective new users m until a condition for terminating is reached.

Some embodiments may further comprise assigning an order of priority to the users and selecting the users m in the order of priority. Priority may be awarded, for example, based on the link condition of each user, with highest priority awarded to worst link condition. In some embodiments, priority may be awarded based on a total achievable data rate for each user. The total achievable data rate for each user is evaluated, e.g., by summing the subcarrier-dependent net bit rate for that user over all subcarriers in the spectrum.

In embodiments, the grouping of subcarriers for each user m may further comprise, after the designating and removing steps, performing the following at least once:

Assigning a same modulation format for all subcarriers in group m and evaluating an average bit error rate (BER) for group m; if the average BER is greater than the target BER, and adding the next subcarrier in the sorted order to group m. It should be noted in this regard that the same modulation format is assigned to all SCs in a given group.

In embodiments, the bitstream is encoded with a forward error-correcting code (FEC) before loading data from the bitstream onto the allocated OFDM subcarriers. In some embodiments, the FEC is a hard decision code, and the optimizing an allocation of OFDM subcarriers to users is performed so as to minimize a bit error rate. In other embodiments, the FEC is a soft-decision code, and the optimizing an allocation of OFDM subcarriers to users is performed so as to maximize a normalized generalized mutual information (NGMI).

In a second aspect, the disclosure relates to apparatus for processing of a bitstream for transmission in a point-to-multipoint (P2MP) network. The apparatus may comprise circuitry configured for performing any of the various operations listed above. The apparatus may be comprised within a digital signal processor (DSP). In embodiments, the apparatus may be comprised within an optical line terminal (OLT) of a passive optical network (PON). Within the apparatus, circuitry configured for loading of the data may comprise at least one optical OFDM modulator.

### BRIEF DESCRIPTION OF THE DRAWINGS

FIG. 1 is a simplified schematic drawing, illustrating the concept of a point-to-multipoint (P2MP) network with the non-limiting example of a P2MP optical network such as a passive optical network (PON).

FIG. 2 is a simplified, functional block diagram of an example apparatus for signal modulation, within a transmitter device of a P2MP optical network.

FIG. 3 is a simplified, functional block diagram of an OFDM modulator of the kind that could be used, e.g., in a P2MP network.

FIG. 4 is flowchart of a procedure that may be used, according to herein described principles, for grouping OFDM subcarriers for P2MP transmission.

FIG. 5 is a flowchart of a procedure that may be used, in conjunction with the procedure of FIG. 4, for rate maximization.

FIG. 6 is a flowchart of a procedure that may be used, in conjunction with the procedure of FIG. 4, for ordering of users.

FIG. 7 is an experimentally determined graph of hGMI versus BER, comparing the results from several different schemes for loading and modulation, including the EL-SCG scheme described herein.

FIG. 8 is an experimentally determined graph, comparing hGMI obtained for EL-SCG with hGMI obtained for entropy loading (EL) at a fixed bit error rate (BEL) of 0.01. The graph shows the gap between EL-SCG and EL, as a function of the number of subcarrier groups determined with EL-SCG.

FIG. 9 is a graph showing a profile of signal-to-noise ratio (SNR) versus frequency that was used for modeling studies.

FIG. 10 is a graph, determined from modeling studies, that illustrates the sensitivity of hGMI to chromatic dispersion. The graph compares OFDMA to time-division multiplexing (TDM) for multi-user access.

FIG. 11 is a graph, determined from modeling studies, that illustrates the sensitivity of hGMI to SNR. The graph compares OFDMA to time-division multiplexing (TDM) for multi-user access.

### DETAILED DESCRIPTION

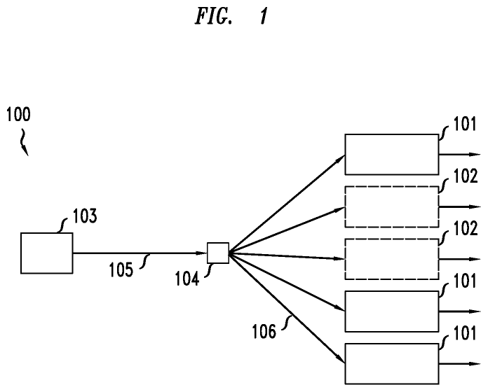

FIG. 1 illustrates a point-to-multipoint (P2MP) network 100. By way of illustration but not of limitation, the illustrated network is an optical network such as a passive optical network (PON), in which an optical signal may be transmitted through fiber connections 105, 106. The network 100 comprises an optical line termination (OLT) 103 placed at the server provider's central office, and multiple optical network units (ONUs) 101, 102. An unpowered optical splitter 104 allows to distribute input received from the OLT 103 toward the connected ONUs 101, 102. The figure illustrates that a single optical fiber 105 serves multiple endpoints 101, 102, such that one optical signal is broadcast to every connected endpoint 101, 102.

In FIG. 1, two different types of receivers 101, 102 are indicated as being present in the network 100. This is to illustrate that the same P2MP network may support a variety of different user types, with different rate demands and different levels of link quality.

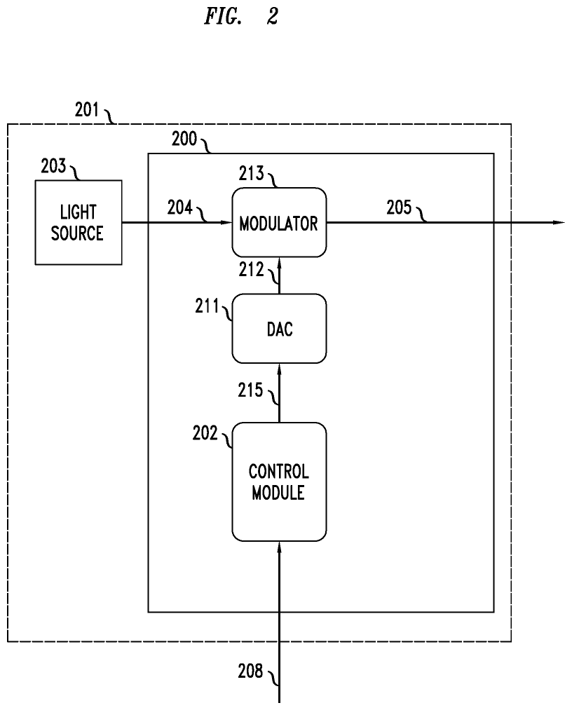

FIG. 2 gives a highly simplified functional block scheme of an example embodiment of an apparatus 200 for optical signal modulation. The apparatus 200 is comprised in a transmitter device 201. For example, the transmitter device 201 may be comprised in an optical line terminal (OLT) such as OLT 103 of FIG. 1.

The transmitter device is adapted to transmit a modulated optical signal 205 toward the end-user side. The apparatus 200 is configured to modulate a single-wavelength carrier wave 204, and comprises a first module 201 and a second module 202. The apparatus 200 receives the carrier wave 204 from a light source 203, e.g., a laser source. The apparatus 200 is configured to modulate one or more carrier waves 204 by means of one or more modules 202.

The apparatus is configured to receive digital data 208. The apparatus 200 may further comprise one or more digital-to-analog converters (DACs) 211 to convert digital control data 215 generated by module or modules 202 into electrical signals 212, that are used to control a modulator 213.

The modulator 213 comprises optoelectronic componentry for modulating optical intensity, optical phase, and/or optical polarization, and it comprises circuitry configured to perform the signal processing and control necessary to produce the modulated optical signal. The signal processing is typically carried out by circuitry in a suitably configured digital signal processor (DSP).

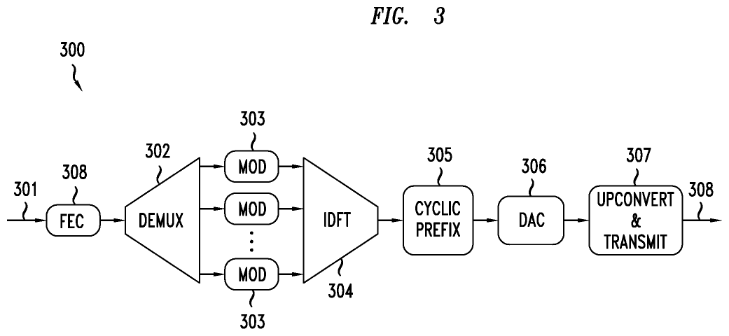

FIG. 3 is a highly simplified, functional block diagram of an OFDM modulator 300 of the kind that could be used, e.g., in a P2MP network. As shown in the figure, a forward error-correcting code (FEC) 308 is applied to in input bitstream 301, after which demultiplexer 302 distributes the bitstream into multiple substreams that are mapped to constellation symbols in respective modulator elements 303 and recombined into a single output stream by inverse discrete Fourier transform (IDFT) module 304.

The entropy loading operation described below would typically be carried out in the modulator elements 303, which would typically be implemented in one or more suitably configured DSPs.

Turning back to FIG. 3, cyclic prefixes are added to the IDFT output at module 305, according to known practices in OFDM modulation. The digital output stream from module 305 is converted to an analog output stream at DAC 306, and it is conditioned for transmission at element 307. The conditioning at element 307 may, in implementations, include upconversion to a desired frequency for transmission. After suitable conditioning, the signal is transmitted as transmitted signal 308.

As noted above, entropy loading (EL) may be included in the generation of modulated signals in the respective sub-channels, i.e., on the respective OFDM subcarriers. According to our new technique, subcarrier grouping (SCG) is performed in conjunction with entropy loading. Accordingly, we refer to our new technique as EL-SCG.

The entropy loading is implemented using prior knowledge of the link conditions of all of the users. This knowledge may be acquired, for example, by sending probe signals to acquire the SNR map across the spectrum.

Briefly, EL is a function to determine the modulation format of each subcarrier, given a loading target such as bit error rate (BER) and a measure of the SC quality, such as signal-to-noise ratio (SNR). By contrast, EL-SCG is a procedure that relies on EL. Its goal is to assign subcarriers to multiple users in a manner that is optimal according to some criterion, such as maximizing the data rate. In operation, EL-SCG utilizes the basic EL algorithm to determine the modulation format.

For optimization, two alternative targets are of interest. Given a fixed performance threshold such as BER, a suitable objective would be to maximize the data rate, as in the example provided below. On the other hand, given a fixed user rate demand, a suitable objective would be to optimize the performance, exemplarily by minimizing the BER. Similar techniques can be used to achieve either objective.

An example embodiment uses bit error rate (BER) as the loading target. This choice is consistent with hard decision forward error correction (HD-FEC) coding, which is typical in IM-DD networks. For system metrics, the example embodiment uses both BER and generalized mutual information under binary HD decoding (hGMI). The hGMI is defined by:

$$hGMI = ( X ) - log 2 \vert 𝒳 \vert \cdot {2}_{} ( ϵ ) ,$$

where
[symbol] (X) is the entropy of signal X;
[symbol] ₂(⋅) is the binary entropy function;
ϵ is the bit error probability; and
   |χ| is the size of the modulation alphabet.

Using a binary HD-FEC code of rate c, the net bit rate [symbol] is calculated as

$$= ( X ) - {log}_{2} \vert 𝒳 \vert \cdot ( 1 - c ) .$$

The rate [symbol] has hGMI as an upper bound. [symbol] is equal to hGMI for an ideal HD-FEC that corrects ϵ with c=1− [symbol] ₂(ϵ).

In the example embodiment, EL-SCG is implemented with the following Algorithm EL-SCG, which is suitable either for users with identical link conditions or for users with multiple link conditions. The EL-SCG algorithm includes a pre-loading step that uses an EL algorithm.

As known in the art, EL effectuates a continuous entropy adjustment by probabilistic constellation shaping (PCS), which assigns different probabilities to different constellation points. Although the size of the modulation alphabet is integral, the adjustment of probabilities makes possible a continuous ajustment of the entropy [symbol] .

Given the subcarrier quality (as characterized, e.g., by SNR), and given a loading target such as BER, there will be a probabilistically-shaped modulation format, with an entropy [symbol] , that exactly matches the loading target under the given SNR. The pre-loading step maps the subcarrier quality and loading target to a modulation format, as characterized by entropy [symbol] . Given the FEC overhead, the rate [symbol] is calculated from the entropy [symbol] .

For applications to PON, cable access, or other types of fixed network, embodiments of our technique would be useful, e.g., for network recalibration at intervals on the scale of weeks or months, although shorter or longer intervals are not excluded. For networks with less link stability, such as wireless networks, much shorter intervals could be desirable. In some cases, it could be desirable to repeat the procedure for acquisition of channel information each time a central office, e.g., sends information to a user.

An example EL algorithm suitable for the purpose of pre-loading is provided in D. Che et al., “Squeezing out the last few bits from band-limited channels with entropy loading.” Optics Express, vol. 27, no. 7, pp. 9321-9329, (2019), the entirety of which is hereby incorporated herein by reference. In Che et al., a look-up table is used. The look-up table is acquired by Monte-Carlo simulations with AWGN channels, using an SNR map acquired, e.g., with probe signals. The look-up table stores the relations between hGMI and channel SNR for all the available modulation formats. It is noteworthy in this regard that, as noted above, the entropy H takes continuous values for EL.

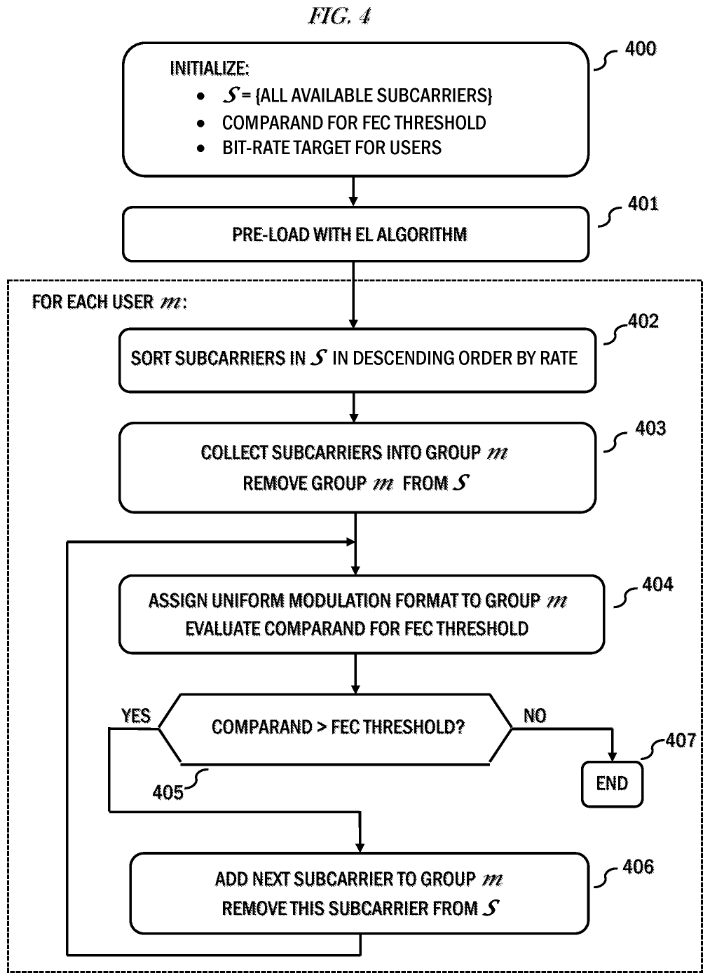

An example implementation of our technique, which is here referred to as Algorithm EL-SCG, will now be described with reference to FIG. 4.

It should be noted that a “user” as the term is used here may be an individual user or a group of users that have been determined to have a similar link condition and that have been grouped together by a user grouping algorithm. User grouping is discussed, e.g., in R. Borkowski et al., “FLCS-PON—an opportunistic 100 Gbit/s flexible PON prototype with probabilistic shaping and soft-input FEC: operator trial and ODN case studies,” Journal of Optical Communications and Networking, vol. 14, no. 6, pp. C82-C91, (2022), for flexible rate passive optical networks (FLCS-PON). It is also discussed, e.g., in Haleema Mehmood et al., “Bit Loading Profiles for High-Speed Data in DOCSIS 3.1,” IEEE Communications Magazine, vol. 53, no. 3, pp. 114-120, 2015.

### Algorithm EL-SCG

### Initialize (Block 400):

Initialize the set [symbol] as the “spectrum”, i.e., as the set of all available SCs.

Initialize a target, here denominated the “FEC Threshold” for the forward error-correction code. If the FEC code is hard decision, the bit error rate (BER) is a suitable target. If the FEC code is soft decision, normalized generalized mutual information (NGMI) is a suitable target.

Initialize bit-rate target [symbol] (m) for each user m, m=1, 2, . . . , M.
(1) Perform pre-loading (block 401) with an EL algorithm, to determine [symbol] and [symbol] for each subchannel and for the link condition of each user.

This step provides a table, or the equivalent, that may be regarded as listing, for each subchannel, every user's [symbol] and [symbol] based on the underlying condition of that user's link. Alternatively, the table or equivalent may be regarded as listing for each user, every subchannel's [symbol] and [symbol] .
(2) Sort (block 402) the SCs in [symbol] by a descending order based on their [symbol] in the underlying link condition. Do this for the link condition of all users m.
   For m=1,2, . . . , M, Perform for User m:
(3) Collect (block 403) subcarriers into Group m; Group the SCs in the sorted order from highest to lowest rate until their collective bit-rate reaches or exceeds [symbol] (m). Denominate these SCs as Group m, and denominate the number of SCs in Group m as N(m). Remove Group m from [symbol] .
(4) Assign (block 404) a uniform entropy [symbol] (m) to Group m according to:

$$( m ) = ( m ) / N ( m ) + log 2 \vert 𝒳 ( m ) \vert \cdot ( 1 - c ) ,$$

and then evaluate the average BER (for hard-decision FEC, for example), the nGMI (for soft-decision FEC, for example), or other suitable comparand, i.e., other suitable measure to be compared against the FEC target. More generally, the step of assigning the uniform entropy is performed by assigning the same modulation format to all subcarriers in Group m.
(5) Compare (block 405) the comparand to the FEC target. If the comparison fails, for example if the comparand is average BER and, as shown in the figure, it is larger than the target, add (block 406) the next SC in the sorted order to Group m and return to Step (4).

### End

The SC sort in step (2) aims to minimize the SNR difference within a group to avoid an extra power loading. Although an iteration is evidently possible between Steps (4) and (5), it is expected to be rare in practice, because the rate gap between EL-SCG and EL is expected to be very small.

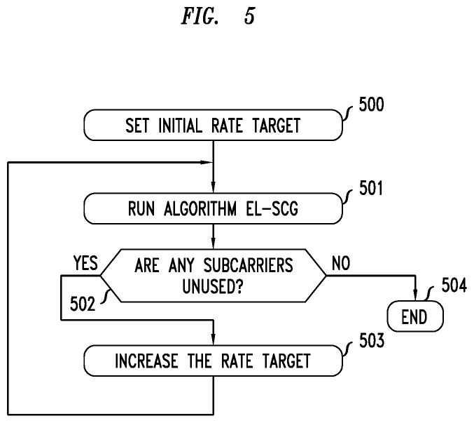

FIG. 5 is a flowchart of an example procedure for maximizing the total data rate that is achieved. At block 500, an initial rate target is set for, e.g., all OFDMA users. At block 501, Algorithm EL-SCG is run. After Algorithm EL-SCG has run, the procedure checks, at block 502, whether there are any remaining, unused subcarriers. If there are none, the procedure terminates (block 504). If there are remaining, unused subcarriers, the procedure increases the rate target (block 503) and returns to block 501 to run Algorithm EL-SCG a further time. Thus, the rate target is increased until no further subcarriers are available.

In scenarios in which all the users have the same link condition, it does not matter whose SCs are assigned first. The SCG order, i.e., the numbering of respective users as m=1, m=2, etc., does matter, however, for a P2MP network with multiuser diversity. There, the aggregated multiuser capacity depends on how priorities are assigned to respective users, because once an SC is assigned to one user, it cannot be occupied by another user with a different link condition.

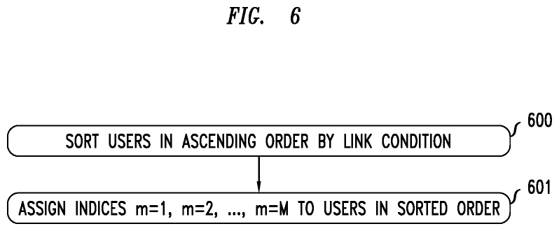

Various strategies may be used to find an SCG order. FIG. 6 is a flowchart of an example strategy. The strategy of FIG. 6 is a simple, sub-optimal user sorting strategy in which the users are sorted in ascending order based on the quality of each user's link condition, so that the worse-case users have higher priority and are assigned better SCs. The link condition for each user is evaluated, for example, as the total achievable data rate Σi [symbol] (i), where i is the SC index, [symbol] (i) is dependent on the link condition for the given user, and the summation is taken over all SCs in the spectrum.

Turning to FIG. 6, the users are sorted at block 600 in ascending order by link condition. At block 601, indices m=1, m=2, etc., up to m=M are assigned to the users in the sorted order, wherein M is the total number of users.

### Example I—Experimental

Principles as described above were tested experimentally by observing downstream transmission in an IM-DD setup with 100-GHz end-to-end bandwidth. A1:4 optical splitter emulated multiple link conditions. Each branch consisted of a standard single-mode fiber spool (60-m step variable length) to add chromatic dispersion (CD) of 17 ps/nm/km at 1550 nm, equivalent to about 1 ps/nm every 60 m. Each branch also included a variable optical attenuator to add extra optical path loss (OPL).

The OFDM signal had a DFT size of 2048 and a SC spacing of 0.125 GHZ, leading to 800 data-carrying SCs in total within 100-GHz bandwidth. Each OFDM symbol had a 16-point cyclic prefix. A PAM signal included for comparison was pulse-shaped by a 0.01 roll-off root-raised cosine (RRC) filter with a fixed 200-GBd symbol rate but variable orders (up to PAM-8) and entropies for rate adaptation. The receiver used a 1-tap per SC equalizer for OFDM and a 2048-tap equalizer for PAM, to have the same time duration for equalization.

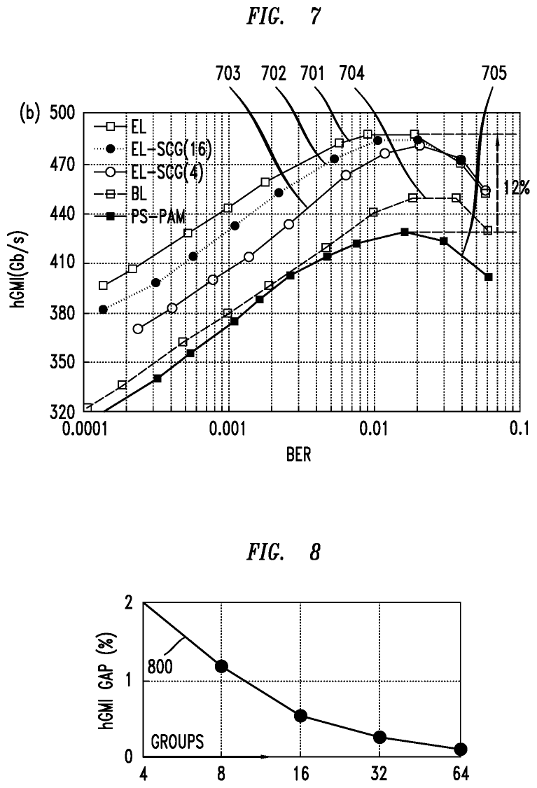

In a demonstration, we chose a link with 5-ps CD, with 8-dBm input to the photodiode, and with bandwidth limited mainly by the electronic transmitter, which produced larger noise at high frequencies, and by the frequency selective fading due to CD. FIG. 7, which is a graph of hGMI versus BER, compares the hGMI obtained for EL (top curve 701), EL-SCG with sixteen SC groups (second curve from top 702), EL-SCG with four SC groups (third curve from top 703)), BL (second curve from bottom 704), and PS-PAM (bottom curve 705). In this comparison, the EL performance is seen to be superior to the other modulation schemes, as expected due to probabilistic-shaping (PS) gain and the precise adaptation of entropy per SC. EL-SCG is seen to exhibit an hGMI gap to EL, particularly for the smaller number of groups. However, the gap is seen to shrink rapidly for higher BER targets.

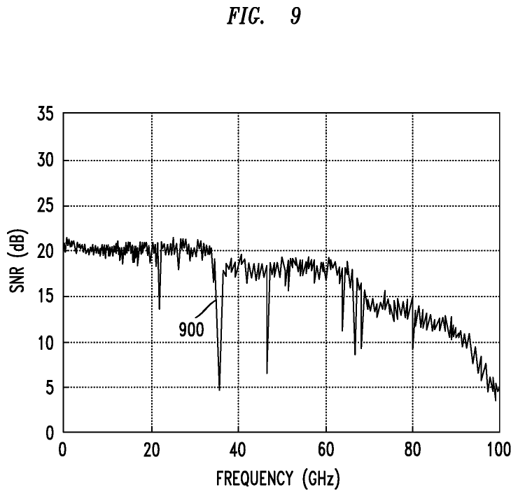

FIG. 8 shows, as a function of the number of SC groups, the EL-SCG gap to EL at a BER of 0.01, which is plotted as curve 800. It is evident that the penalty for SCG is below 0.6% if the group number (i.e., the number of users) is 16 or more.

### Example II—Simulation

In a P2MP IM-DD network, the link conditions are mainly diversified in CD and OPL. The diversity represented by CD is manifested as a colored SNR difference, whereas the diversity represented by OPL is manifested as a white SNR difference, i.e., as a SNR change that is independent of frequency. We performed simulations that separated the effects of CD from the effects of OPL. The simulations predicted that using OFDMA to divide the spectrum among users would be beneficial for both types of user diversity, with performance surpassing that of the TDM approach.

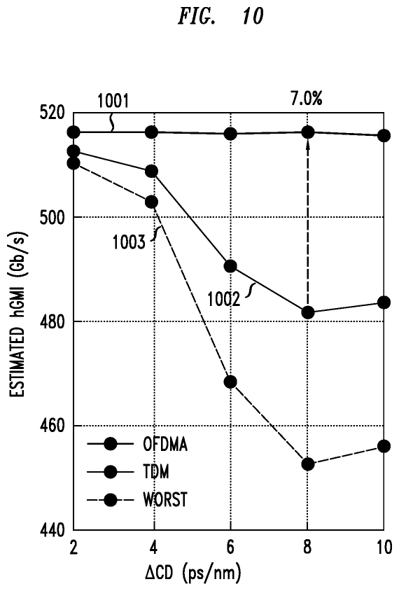

Using experimentally measured SNR profiles, the simulation evaluated the hGMI with a BER target of 0.01. To simplify the analysis, we assumed two clusters, containing eight users each, of users having similar link conditions. For the CD case, the reference cluster fixed its CD as 0 ps and the other varied the CD up to 10 ps: for the OPL study, the reference was the SNR profile 900 in shown in FIG. 9, and the other cluster had a white SNR reduction.

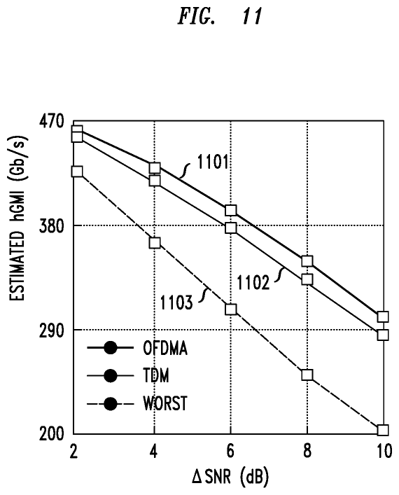

FIG. 10 is a graph of estimated hGMI versus the change ΔCD in the chromatic dispersion between the control and variable clusters. FIG. 11 is a graph of the estimated hGMI versus the change ΔSNR in the SNR between the control and variable clusters. To produce FIGS. 10 and 11, we assumed that one cluster of users has a fixed link condition CD1, and that the other cluster of users had a variable link condition CD2. We defined ΔCD as the difference between the two link conditions, i.e., ΔCD=CD2−CD1.

In each graph, the top curve, i.e., curve 1001 in FIG. 10 and curve 1101 in FIG. 11, represents the OFDMA case, the middle curve, i.e., curve 1002 in FIG. 10 and curve 1102 in FIG. 11, represents the TDM case, and the bottom curve, i.e., curve 1003 in FIG. 10 and curve 1103 in FIG. 11, represents the case wherein all users operate at the worst-case link condition.

The superior performance of OFDMA in FIG. 10 can be explained by avoidance of CD degradations, because in OFDMA, bad users with fading get the priority to occupy good SCs which are not affected by fading. The superior performance of OFDMA in FIG. 11 can be explained by the policy of awarding good SCs first to the bad users; this policy minimizes the number of SCs awarded (to bad users) for a given rate target. That is, awarding good SCs to bad users results in few SCs being used by the bad users.

We claim:

1. A method, comprising:
obtaining link conditions of a plurality of users at respective user nodes of a point-to-multipoint (P2MP) network that are in communication with a central node of the P2MP network, wherein for each user, the link condition is determined for each subcarrier in a spectrum comprising multiple OFDM subcarriers;
inputting the link conditions to an entropy loading (EL) algorithm, thereby to determine a modulation format for each of the OFDM subcarriers;
optimizing an allocation of OFDM subcarriers to users according to an OFDMA scheme; and
for each user, loading data from a bitstream onto the allocated OFDM subcarriers in the respective determined modulation formats.

2. The method of claim 1, further comprising transmitting the loaded data in parallel, between the user nodes and the central node, on the OFDM subcarriers.

3. The method of claim 2, wherein the transmitted data is transmitted in parallel from the central node to the user nodes.

4. The method of claim 1, wherein the optimizing an allocation of OFDM subcarriers comprises maximizing a data rate.

5. The method of claim 1, wherein the optimizing an allocation of OFDM subcarriers comprises minimizing a bit error rate.

6. The method of claim 1, wherein the P2MP network is a PON, and wherein the loading of the data for each user comprises optical OFDM modulation.

7. The method of claim 1, wherein the optimizing an allocation of OFDM subchannels to users comprises grouping at least some of the subcarriers into one or more SC groups, and allocating each SC group to a respective user.

8. The method of claim 7, wherein the EL algorithm provides, as output, a signal entropy and a net bit rate for each subcarrier under the link condition of each user; and wherein the grouping of subcarriers comprises:
from a set of available subcarriers, sorting the subcarriers in descending order of their net bit rates based on the link conditions of the respective users;
selecting a user m;
taking subcarriers in the sorted order from highest to lowest rate and binning them until their collective net bit rate reaches or exceeds a bit-rate target for user m;
designating the binned subcarriers as subcarrier group m;
removing the subcarriers of subcarrier group m from the set of available subcarriers; and
repeating the selecting, sorting, taking, designating, and removing steps for respective new users m until a condition for terminating is reached.

9. The method of claim 8, wherein for each user m, the grouping of subcarriers further comprises, after the designating and removing steps, at least once:
assigning a same modulation format to all subcarriers in subcarrier group m;
evaluating an average bit error rate (BER) for group m; and
if the average BER is greater than a target bit rate, adding the next subcarrier in the sorted order to group m.

10. The method of claim 8, further comprising assigning an order of priority to the users, wherein:
priority is awarded based on the link condition of each user with highest priority awarded to worst link condition; and
the users m are selected in the order of priority.

11. The method of claim 10, wherein:
priority is awarded based on a total achievable data rate for each user; and
the total achievable data rate for each user is evaluated by summing the subcarrier-dependent net bit rate for that user over all subcarriers in the spectrum.

12. The method of claim 1, further comprising encoding the bitstream with a forward error-correcting code (FEC) before loading data from the bitstream onto the allocated OFDM subcarriers.

13. The method of claim 12, wherein the FEC is a hard decision code, and wherein the optimizing an allocation of OFDM subcarriers to users is performed so as to minimize a bit error rate.

14. The method of claim 12, wherein the FEC is a soft-decision code, and wherein the optimizing an allocation of OFDM subcarriers to users is performed so as to maximize a normalized generalized mutual information (NGMI).

15. Apparatus comprising:
circuitry configured for obtaining link conditions, in a spectrum comprising multiple OFDM subcarriers, of a plurality of users at respective user nodes of a point-to-multipoint (P2MP) network;
circuitry configured for inputting the link conditions to an entropy loading (EL) algorithm and for executing the EL algorithm, thereby to determine a modulation format for each of the OFDM subcarriers;
circuitry configured for optimizing an allocation of OFDM subcarriers to users according to an OFDMA scheme; and
circuitry configured for loading data, for each user, from a bitstream onto the allocated OFDM subcarriers in the respective determined modulation formats.

16. The apparatus of claim 15, comprised within a digital signal processor (DSP).

17. The apparatus of claim 15, comprised within an optical line terminal (OLT) of a passive optical network (PON).

18. The apparatus of claim 15, further comprising circuitry configured for transmitting the loaded data in parallel on the OFDM subcarriers.

19. The apparatus of claim 15, wherein the circuitry configured for loading of the data comprises at least one optical OFDM modulator.

20. The apparatus of claim 15, further comprising circuitry configured for encoding the bitstream with a forward error-correcting code (FEC) before loading data from the bitstream onto the allocated OFDM subcarriers.
